(19) United States
(12) Patent Application Publication
(10) Pub. No.: US 2009/0194679 A1
(43) Pub. Date: Aug. 6, 2009

(54) METHODS AND APPARATUS FOR REDUCING NOISE IN MASS SPECTROMETRY

(75) Inventors: Thomas P. Doherty, San Mateo, CA (US); Jeffrey T. Kernan, Santa Cruz, CA (US); James D. Foote, Sunnyvale, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies, Inc., Palo Alto, CA (US)

(21) Appl. No.: 12/023,385

(22) Filed: Jan. 31, 2008

(51) Int. Cl. H01J 49/26

(52) U.S. Cl. 250/282; 250/288

(57) ABSTRACT

The invention pertains to methods and apparatus for performing mass spectrometry with reduced noise. In some embodiments, an additional amount of a carrier gas is introduced into a mass spectrometer to reduce the noise.

### FIELD OF THE INVENTION

The invention pertains to mass spectrometry. More particularly, the invention pertains to methods and apparatus for reducing noise in mass spectrometry.

### BACKGROUND OF THE INVENTION

Mass spectrometry (MS) is a well-known technique for detecting the identities and/or quantities of constituents of a sample. A mass spectrometer is able to separate the analyte constituents of a sample by their mass to charge ratio (hereafter m/z or m/z ratio). Although there are many different designs for mass spectrometers that operate on different principles of separation by m/z ratio, most mass spectrometers consist of four basic parts. Particularly, virtually all mass spectrometers comprise an ion source for producing ions from the sample, a mass analyzer for separating ions of differing m/z ratios, a detector for detecting the number of ions of each m/z ratio produced, and a data analyzer for collecting the data and generating a mass spectrum. There are different known techniques for each of these stages of a mass spectrometer.

The source stage of a mass spectrometer typically comprises an ionization volume, wherein the constituents of the sample are ionized. In gas phase mass spectrometry, for example, a carrier gas carrying the sample gas is introduced into the ionization volume. Common carrier gasses include helium, hydrogen, and nitrogen. There are several well known techniques for ionizing a sample, including, but not limited to, electron impact ionization techniques and chemical ionization techniques.

For example, in electron impact ionization, the sample is bombarded with an electron beam from the ionization source with a known energy, usually about 70 eV, which is greater than the energy necessary to ionize most analytes. This energy also is sufficient to create ions and non-ionized, excited-state metastables of the carrier gas.

There also are several well known types of mass analyzers for separating the ions by m/z ratio. One such type is a quadrupole mass spectrometer, wherein an electromagnetic field is generated by applying radio frequency (RF) and direct current (DC) signals between four elongated poles with the RF adjusted to selectively stabilize ions of a certain m/z ratio while destabilizing ions of other m/z ratios. The stabilized ions travel down a path parallel to and between the rods, while the destabilized ions are directed out of the path radially.

Next, a detector is positioned to receive and detect the ions of the selected m/z ratio. Finally, a data analyzer analyzes the output of the detector to determine the m/z ratios of the ions and/or their concentrations to determine the constituents of the sample and their quantities.

Since ions of different species may have the same m/z ratio, one cannot necessarily distinguish between two species in the sample that have the same or very close m/z ratios with a single stage mass spectrometer. Accordingly, tandem mass spectrometers are known wherein two or more mass analyzer stages are arranged sequentially, possibly with a collision cell between the stages. For instance, a first MS stage may separate the analytes by m/z ratio using one of the known MS techniques. Then, the ions that have passed through the first stage may be introduced into a collision cell, in which those ions are collided with other molecules with sufficient energy to fragment them into smaller ionized constituents. Those fragments are then introduced into a second MS stage, wherein those fragments are separated by m/z ratio by the same or a different MS technique. This provides a greater ability to distinguish two atomically dissimilar analytes in a sample having the same or very close m/z ratios since it is unlikely that two different molecules having similar m/z ratios would also yield collision fragments having the same m/z ratios.

The creation of excited state carrier gas molecules in the ionization volume, as previously mentioned, is believed to be a source of noise in an MS measurement system, which lowers the signal to noise ratio and decreases the sensitivity of the instrument. While all of the details of the exact causes of such noise are not completely understood, at least some of the noise is believed to be the result of those carrier gas metastables striking the detector surface and thus being detected.

Many mass spectrometer designs incorporate curved ion guides in order to prevent metastable atoms from reaching the detector. Specifically, because metastable atoms are not charged, they are not guided by the electromagnetic guiding fields that guide the charged ions along the curved ion paths. Rather, they will follow a generally straight path, and, therefore, not reach the detector. Both approaches require compromises and constraints on the performance of the system. Further, significant noise remains even when both approaches are combined.

### BRIEF DESCRIPTION OF THE DRAWINGS

FIG. 1 is a block diagram illustrating a first set of embodiments of a gas chromatograph/mass spectrometer in accordance with the principles of the present invention.

FIG. 2A is a block diagram illustrating another embodiment of a mass spectrometer in accordance with the principles of the present invention.

FIG. 2B is a block diagram illustrating yet another embodiment of a mass spectrometer in accordance with the principles of the present invention.

FIG. 3 is a graph showing experimental results indicative of the reduction in background noise achieved using the principles of the present invention in a measurement system as compared to an equivalent system not employing the present invention.

FIG. 4 is a flow diagram illustrated the steps associated with a particular embodiment of the present invention.

### DETAILED DESCRIPTION OF THE INVENTION

The inventors have surmised that at least a significant portion of the noise resulting from the existence of metastables of the carrier gas in the sample is due to the metastables of the carrier gas colliding with background gasses anywhere between the ionization volume and the detector surface, thereby creating ions of the background gasses. Specifically, although attempts are made to create as close to perfect a vacuum as possible in the detector stage (other than the analyte ions), it is essentially impossible to eliminate all background gasses in a mass spectrometer. Some background gasses (typically the expected environmental gasses, such as oxygen, nitrogen, carbon dioxide, argon, etc.) and fluids (most commonly water) virtually always manage to seep into the mass spectrometer. In fact, nitrogen or argon is frequently introduced intentionally in mass spectrometers as a collision gas in collision cells used to fragment ions. Although the collision gas serves a useful purpose in such cases, it nevertheless adversely affects the vacuum if it seeps out of the collision cell into other stages of the mass spectrometer.

The carrier gas metastables can collide with the background gas molecules or collision gas molecules anywhere and at any time inside the mass spectrometer, creating ions of the background gasses. Hence, the ions of the background gasses may strike the detector surface at any time, thereby constituting noise.

Ions of background gasses that are created by such collisions occurring close to the detector are particularly problematic insofar as, the closer to the detector that an ion of a background gas is created, the more likely that the ion will strike the detector surface, and thus become signal noise. Specifically, while there are many ways to detect ions, generally the detector records the charge induced or current produced when an ion passes through a defined aperture or strikes a defined detecting surface (this aperture or surface is the “detector surface”). When ions are created by collisions with carrier gas metastables after the last mass analyzer stage of a mass spectrometer, they are not segregated by mass, as were the analyte ions in the sample. Therefore, they may strike the detector surface at any time regardless of their m/z ratio and be considered to be ions having the particular m/z ratio that corresponds to the particular time that they strike the detector surface. Thus, this phenomenon constitutes noise in the system, which decreases the sensitivity of the system.

In addition, the inventors believe that the widely-held belief that the carrier gas metastables themselves may strike the detector surface constituting noise additional also may be true. Particularly, carrier gas metastables are excited-state molecules, but not ions. Therefore, they do not have a charge. Consequently, metastables are not affected by the guiding electric and/or magnetic fields that operate to separate the analyte ions by their m/z ratios. Hence, they also can reach the detector at a time regardless of their m/z ratio.

The present invention, therefore, seeks to reduce noise in mass spectrometry by reducing the number of carrier gas metastables in the mass spectrometer.

In accordance with the present invention, the sample and the carrier gas (or any other accompanying gas or other transport mechanism) is caused to traverse a volume disposed somewhere after ionizing, but before detecting, intentionally containing a metastable reducing gas, hereinafter termed the metastable reducing gas. The metastable reducing gas should be a species selected relative to the carrier (or other accompanying) gas species so that collisions between the stable molecules of the metastable reducing gas and the metastable molecules of the carrier gas cause the metastables of the carrier gas to return to a stable energy state. Thus, the metastable reducing gas reduces the number of metastables of the carrier gas. In one embodiment, the metastable reducing gas is of the same gas species as the carrier gas carrying the analytes. However, in theory, the metastable reducing gas may be any gas for which the atoms or molecules of the metastable reducing gas can collide with the atoms or molecules of the carrier gas so that the metastables of the carrier gas dissipate their energy and return to their stable states. This generally will encompass any gas the atoms or molecules of which have the same or similar excited energy states as the carrier gas. (Hereinafter, the term molecule will be used as encompassing single atoms as well as multi-atom molecules, unless otherwise stated or required by context.) The metastable reducing gas is introduced into the mass spectrometer at any point after the ionization volume and before the detector surface.

The reduction in noise is believed to be the result of the stable molecules of the metastable reducing gas colliding with the metastable molecules of the carrier gas, thereby causing the metastables to lose energy and become stable again. This reduction in the number of carrier gas metastables in the mass spectrometer reduces noise because it reduces the quantity of background gasses that are ionized by colliding with such metastables, and which might strike the detector surface and become noise. It also reduces noise by reducing the quantity of carrier gas metastables in the flow path of the sample, which also may strike the detector surface and become noise.

The overall increase in molecules of the carrier gas in the mass spectrometer (or carrier gas and metastable reducing gas, if they are of different species) is not problematic because the overall increase is composed of stable molecules; and stable molecules will not ionize background gas molecules by colliding with them. Also, the stable metastable reducing gas molecules themselves do not increase noise because they would not be detected by the detector even if they did strike the detector surface, since they have no charge. In fact, even if the metastable helium molecules collide with the stable, ground-state helium molecules in such a way as to transfer energy resonantly and, thereby, create another metastable helium atom, that atom will have an essentially random trajectory. Therefore, it would be unlikely to strike the detector surface in any event. Thus, not only does this technique reduce the number of metastable helium atoms in the mass spectrometer, but also causes space diffusion of the metastable helium atoms in the beam.

Furthermore, while increasing the pressure of the carrier gas in the mass spectrometer, i.e., introducing more carrier gas, may inherently also increase the production of carrier gas ions in the mass spectrometer, the number of collisions between stable carrier gas molecules and metastable carrier gas molecules in the beam increases by an even greater amount. Hence, in sum, the number of excited-state helium atoms inside the mass spectrometer actually decreases. Thus, quite-counter intuitively, introducing more carrier gas (or other metastable reducing gas) into the mass spectrometer actually decreases the number of carrier gas metastable atoms in the mass spectrometer. In turn, this decreases the number of ions of background gasses generated in the mass spectrometer.

Thus, for instance, if the mobile phase (i.e., carrier gas) in the gas chromatograph of a GC/MS measurement system is helium, then the sensitivity of the mass spectrometer phase of the GC/MS measurement system can be substantially increased by introducing helium as a metastable reducing gas into the mass spectrometer at any point after the ionization volume and before the detector surface. The metastable reducing gas should be introduced in its stable state. As noted above, the metastable reducing gas need not necessarily be of the same species as the carrier gas, but could be a different gas having the same or close quantized resonant energy state as the carrier gas metastables. Such a gas also should have a relatively high likelihood of colliding with a metastable carrier gas molecule and returning it to its stable state. Molecules of other gas species having quantized resonant energy states within about 1 eV of that of the carrier gas metastables should have a significant effect in terms of reducing metastables of the carrier gas. Molecules with quantized resonant energy states within 0.1 eV should have an even greater effect.

As stated above, introducing the metastable reducing gas in the mass spectrometer anywhere after the ionization volume and before the detector surface reduces background noise. However, there are certain factors that it is believed dictate the most effective places to introduce the metastable reducing gas. For instance, since a primary goal of introducing the metastable reducing gas is to cause collisions between the metastable reducing gas and metastables of the carrier gas, the metastable reducing gas should be introduced at a location and in a manner designed to maximize collisions between the metastable reducing gas and metastables of the carrier gas. Thus, it is desirable to provide a region of higher pressure metastable reducing gas having (1) as long a distance for such collisions to occur as reasonable and (2) as high a gas pressure in that region as reasonable.

For instance, whereas it is practically possible to achieve pressures as low as 10⁻⁷ torr in a mass spectrometer, it may be desirable to introduce the metastable reducing gas into a chamber of a mass spectrometer at a pressure as high as 1 torr. However, since higher gas pressures generally adversely impact the sensitivity or operation of some parts of a mass spectrometer, it may be desirable to increase the pressure by a lesser amount. For instance, if the metastable reducing gas is introduced where it will increase the gas pressure at the detector or at a mass analyzer, it may be desirable to increase the gas pressure to a pressure of less than about 10⁻⁴ torr. On the other hand, if the metastable reducing gas is introduced in a location on the opposite side of a conductance limit from the mass analyzer(s) and detector(s), such as inside of a collision cell, it may be reasonable to increase the pressure to as much as 10⁻¹ (100 mTorr) or even 1 torr.

The distance over which the higher pressure metastable reducing gas exists should be as long as is practical given the other design constraints. Merely as an example, lengths as short as 10 mm or shorter may be sufficient to cause enough collisions to significantly reduce noise, especially if the pressure is very high over that length. On the other hand, certain mass spectrometer designs may permit the metastable reducing gas to be present over the entire length of the mass spectrometer between the ionization and the detection of the ions, which might be as long as 1 meter or longer. As another example, if the metastable reducing gas is introduced inside of a collision cell, common path lengths of collision cells range from about 50 mm to about 200 mm. The above lengths are merely exemplary, as the most appropriate distance will be a function of many practical considerations, including the available space, the pressure, the existence or absence of conductance limits, the species of the carrier gas and the metastable reducing gas, etc.

Furthermore, it would be desirable to introduce the metastable reducing gas at a point where the ratio of collisions with existing metastable atoms of the carrier gas to the creation of new ions is as great as is reasonable. This factor would dictate toward introducing the metastable reducing gas in a manner or location that minimizes the chances of the molecules of the metastable reducing gas entering into the ionization volume where they may become metastables. This might be achieved by differentially pumping the source chamber of the mass spectrometer to help prevent downstream gasses from being drawn upstream into the ionization volume or on the opposite side of a conductance limit from the ionization volume.

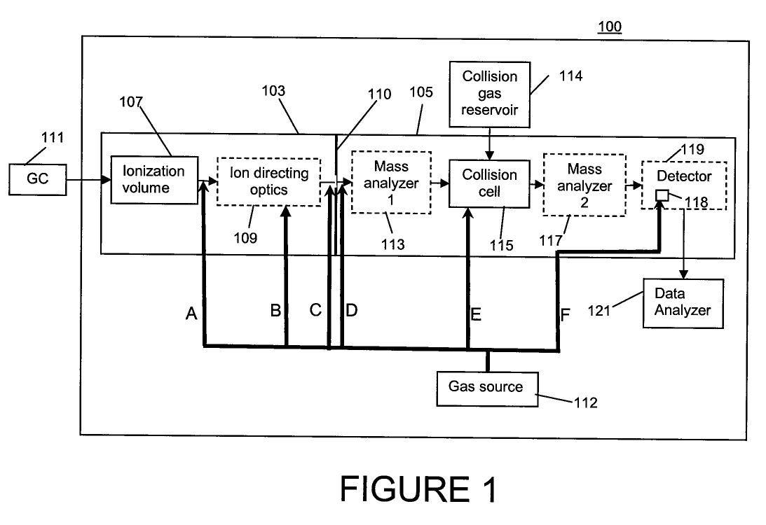

FIG. 1 is a block diagram of a dual stage mass spectrometer 100 incorporating features in accordance with the present invention. It comprises a source chamber 103 followed by an analyzer chamber 105 with a conductance limit 110 therebetween. The source chamber 103 includes an ionization volume 107 where the ions are created, such as by electron impact ionization as previously described. The ionization volume 107 typically is maintained at a different, higher pressure than the remainder of the source chamber 103 since this is where the sample and carrier gas enter the mass spectrometer. The source chamber 103 also usually includes lenses and other ion optics elements, generally denoted by reference numeral 109 in FIG. 1, for directing a beam of the ionized analytes into the analyzer chamber 105. The ion directing optics 109 typically would be outside of the pressurized ionization volume 107 and at the same pressure as the remainder of the source chamber 103. The source chamber 103, other than the ionization volume 107, generally will be maintained at as low a pressure as reasonably possible.

In this example, the analytes to be ionized and analyzed are provided into the ionization volume 107 from a preceding stage, such as a gas chromatograph 111. Specifically, in complex samples containing many analytes, it still may be difficult to properly isolate each analyte by m/z ratio, even using a tandem mass spectrometer. Accordingly, it is common to provide a preceding stage for separating the constituent analytes in a sample based on other characteristics before introduction into the mass spectrometer. A gas chromatograph or GC uses a flow-through narrow column through which the analyte constituents of a sample pass in a gas stream (the carrier gas or mobile phase). The column contains a specific solid or liquid (the stationary phase) that adsorbs and desorbs analytes in the sample. As the carrier gas sweeps the analyte molecules through the column, this motion is inhibited by adsorption of the analyte molecules into the stationary phase. The rate at which the molecules progress along the column depends on the strength of adsorption, which in turn depends on the type of molecule, the stationary phase material, and the temperature. Since each type of molecule has a different rate of progression through the column, the various analytes in the sample reach the end of the column at different times (retention time). Hence, the sample reaches the input of the mass spectrometer with at least some of its analytes already separated as a function of time.

In any event, the sample and carrier gas are introduced from the GC 111 into the ionization volume 107 of the mass spectrometer, where the sample is ionized. The ions are directed by the ion directing optics 109 into an analyzer chamber 105, which, in this example, comprises two mass analyzers 113 and 117 separated by a collision cell 115. For instance, the first mass analyzer 113 may be the quadrupole mass filter that segregates ions as a function of their m/z ratio. The operation of a quadruple mass filter is well-known in the art and, therefore, will not be further explained herein. Also, it should be understood that the quadrupole mass filter is merely exemplary and that the principles of the present invention can be applied to a mass spectrometer using essentially any type of mass analyzer.

The output from the first mass analyzer 113 is fed to a collision cell 115, which causes the ions to collide with the molecules of a collision gas with sufficient force to fragment those ions. The collision gas is introduced into the collision cell from a collision gas reservoir 114 through a port. The fragmented ions are then fed into a second mass analyzer 117, which may, for instance, comprise another quadrupole mass filter. This second quadrupole mass filter 117 is again operated to transmit the fragmented ions toward the detector 119 in an m/z ratio dependent manner.

The detector 119 detects the fragmented ions, which strike the detector surface in a time-dependent manner depending on their m/z ratios, thereby determining the qualitative (m/z ratio) and quantitative (amount) characteristics of the fragmented ions in the sample. The detector output is provided to a data analyzer 121 that determines the analyte constituents of the sample from the detector output data.

It will be understood that, although the figures illustrate the various components in boxes (or blocks) for organizational purposes, the components are not necessarily separated from each other by any physical barrier that could maintain a pressure variance therebetween (i.e., a conductance limit). In FIG. 1, the blocks defined by dashed lines correspond to those components of the mass spectrometer that typically do not have a conductance limit between them and other components of the system. On the other hand, those blocks defined by solid lines correspond to those components that typically do have a conductance limit between them and the other components of the system. Thus, for instance, as previously described, the ionization volume 107 typically has a conductance limit between it and the other components of the mass spectrometer. Also, mass spectrometers oftentimes, although not always, have a conductance limit between the source chamber 103 and the mass analyzer chamber 105, as illustrated in FIG. 1.

FIG. 1 illustrates six different exemplary positions, labeled A through F in the Figure, where the metastable reducing gas can be introduced into the mass spectrometer from a source 112.

For instance, in accordance with exemplary embodiment E, the gas is introduced in the collision cell.

The gas can be introduced in any suitable manner, including, but not limited to, a mass flow controller or an electronic pressure sensor coupled to a port into the mass spectrometer.

In the exemplary embodiment of FIG. 1, the noise reduction is particularly dramatic when the metastable reducing gas is introduced at point E, i.e., in the collision cell. The noise reduction is particularly dramatic in this embodiment because the metastable reducing gas is being introduced into a region having a significant path length and wherein the gas pressure can be set relatively high without significantly increasing the gas pressure in the sensitive mass analyzer and detector stages of the mass spectrometer. This embodiment provides ample opportunity for collisions between the molecules of the metastable reducing gas and the metastable helium ions.

Also, the collision cell 115 (and thus point E) is separated from the ionization volume by two conductance limits (i.e., conductance limit 110 between the source chamber 103 and the analysis chamber 105 and the conductance limit of the collision cell itself), thus reducing the chance that metastable reducing gas will flow into the ionization volume and create more metastables. The conductance limits of the collision cell itself are particularly useful because it is well known that the operation and sensitivity of many parts of a mass spectrometer are adversely affected by higher pressures, most notably the mass analyzers and detectors. This is the reason that the pressure level in a mass spectrometer is usually kept as low as possible except in the ionization volume. Thus, introducing the metastable reducing gas in the collision cell 115 is particularly beneficial because it already is a high pressure region within the analyzer stage into which the metastable reducing gas can be introduced without significantly increasing the pressure at the mass analyzers 113, 117 and the detector 119, which are adversely affected by increased pressure.

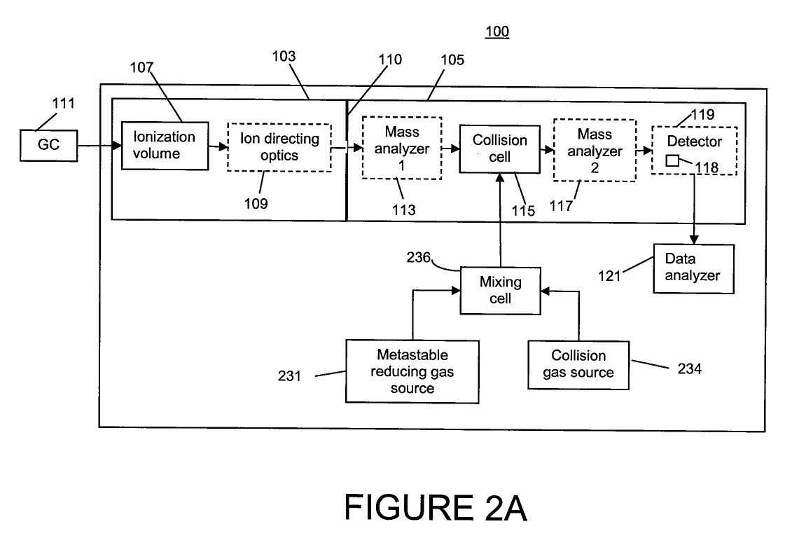

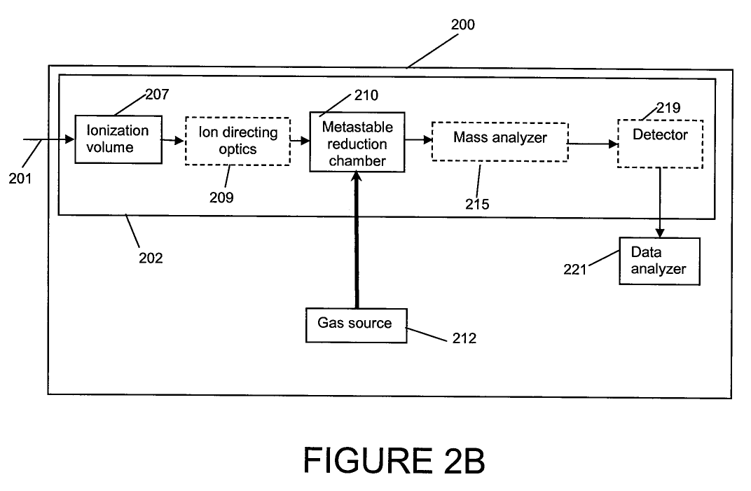

In the exemplary embodiment of FIG. 1, the metastable reducing gas and the collision gas are introduced into the collision cell 115 through two separate ports and mix in the collision cell. However, in an alternative embodiment illustrated by FIG. 2A, the collision gas and the metastable reducing gas can be mixed in a mixing cell 236 (supplied with the two gasses from separate reservoirs 231, 234) outside of the flow path of the sample and introduced into the collision cell 115 through a single port.

Another useful location for introducing the metastable reducing gas is illustrated by F in FIG. 1, just before the detector surface. It should be noted that the detector block 119 corresponds to the detector equipment block. Accordingly, as illustrated by embodiment F, the metastable reducing gas may be introduced even in the detector block 119 as long as it is before the actual detector surface. This is believed to also be a particularly good location to introduce the metastable reducing gas because it would have minimum impact on the mass analyzer and fragmentation functionality of the mass spectrometer. This could be accomplished, for instance, by the addition of only a short high pressure antechamber 118 to the detector 119.

While locations E and F are particularly useful locations to introduce the metastable reducing gas, other locations also are suitable. In fact, introducing the metastable reducing gas anywhere in the analyzer chamber 105, such as illustrated by location D, will have some effect in terms of reducing noise. Even further, the metastable reducing gas can be introduced in the source chamber 103, as long as it is introduced outside of the ionization volume 107, where most of the helium metastable atoms are likely created. Thus, for instance, the metastable reducing gas may be introduced at point B, in the lensing portion 109 of the source chamber 103. In one embodiment (not illustrated), the ion directing optics section 109 may be maintained at a separate, higher pressure and the metastable reducing gas introduced therein. Such an embodiment would have the advantage of providing a higher pressure zone for the metastable reducing gas to collide with the metastables of the carrier gas than might otherwise be practically achievable without significantly increasing the pressure elsewhere in the system where higher pressure is undesirable.

Alternately, the metastable reducing gas may be introduced at point C illustrated in FIG. 1, after the ion directing optics 109 but still within the source chamber 103.

How close one can get to the ionization volume 107 at the one end (or the detector surface at the other end) depends entirely on the particular design of the mass spectrometer measurement system. Accordingly, metastable reducing gas introduction point A illustrates the fact that it may even be possible to introduce the metastable reducing gas right after the ionization volume 107, depending on the specific design of the source chamber 103 of the mass spectrometer.

Note that, since, in FIG. 1, there are no conductance limits between points A, B, and C, as a practical matter, there is no significant difference between those points. That is, metastable reducing gas introduced at any of those three locations will disperse throughout the entire source chamber 103 and thus increase the pressure in the entire source chamber (outside of the actual ionization volume 107, which has a conductance limit and, thus, is at a different pressure than the remainder of the source chamber 103). In fact, in some systems, there may not even be a conductance limit such as conductance limit 110 illustrated in FIG. 1 defining separate ionization and analyzer chambers. In such a case there would be little practical difference between any of locations A, B, C, and D.

It should be understood that the exemplary system described above in connection with FIGS. 1 and 2A are just that, exemplary, and that the invention can be applied to any mass spectrometer having any number of stages and using any type of mass analyzing technique, ionization technique, collision technique, detection technique, or data analyzing technique. It also should be understood that the particular location where the metastable reducing gas is introduced illustrated in the exemplary embodiments described in connection with FIG. 1 also are merely exemplary and that the metastable reducing gas can be introduced essentially anywhere between the ionization volume and the detector surface.

FIG. 2B, for instance, illustrates a very simple embodiment of a mass spectrometer 200 incorporating the principles of the present invention. The pressure controlled portion of the mass spectrometer 200 is shown inside of box 202. In this simple embodiment, a carrier gas including a sample gas is introduced into an ionization volume 207 via a port 201. The ions generated in the ionization volume 207 are directed by lensing and other ion optics 209 into a metastable reduction chamber 210. A metastable reducing gas from source 212 is introduced into the metastable reduction chamber 210 to cause collisions between the molecules of the metastable reducing gas and any metastables of the carrier gas. The metastable reduction chamber 210 includes conductance limits between the chamber 210 and the remainder of the mass spectrometer so that it may be maintained at a different, higher pressure. The structure of the metastable reduction chamber 210 may be largely identical to a conventional collision cell even though it is not used for fragmenting the sample ions. The metastable reduction chamber 210 should have a sufficient path length and pressure to assure that a substantial number of the carrier gas metastables will experience a collision with a metastable reducing gas molecule in this chamber. The metastable reduction chamber 210 is followed by a mass analyzer 215 and a detector 219. The data from the detector is sent to a data analyzer 221.

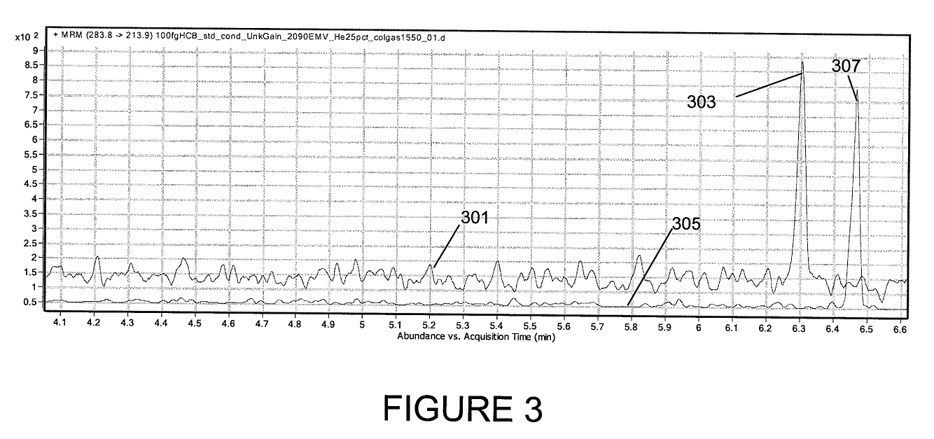

FIG. 3 is a graph illustrating experimental results showing relative background noise levels both employing the present invention and not employing the present invention using a spectrometer in accordance with the design generally illustrated by FIG. 1.

Specifically, curve 301 in FIG. 2 shows the measurement results for an experimental sample containing one analyte, particularly, hexachlorobenzene. The peak in the mass spectrum appears at 303 in curve 301. The remainder of the spectrum represented in line 301 is background noise.

An identical sample was run through the same system, but with additional carrier gas, helium, being introduced into the collision cell, as illustrated by point E in FIG. 1, at a rate of 2.5 ml per minute. This experiment is represented by line 305 in FIG. 3. As can be seen, the peak 307 is essentially identical to the peak 303 (ignoring the slight time shift due to a lack of synchronization between sample injection and the start of data acquisition). Note that the background noise level in curve 305 is substantially decreased as compared to curve 301. In fact, it is decreased by about an order of magnitude. As also can be seen, peak 307 also has been reduced relative to peak 303 on curve 301 by about the same amount as the reduction in background noise, which is to be expected of course since there is noise in the peaks just as there is noise everywhere else in the spectrum.

Thus, the present invention can increase signal to noise ratio by an order of magnitude and, therefore, enable detection of analyte concentrations about an order of magnitude lower than in the state-of-the-art.

The introduction of the metastable reducing gas into the mass spectrometer should have essentially no impact on the ions of the analytes in the sample.

As introducing the metastable reducing gas in a collision cell appears to be particularly effective at reducing noise, it may even be desirable to add a distinct higher pressure cell in some applications simply for the purpose of introducing the metastable reducing gas and allowing molecules of the metastable reducing gas to collide with molecules in the sample (herein termed a “metastable reduction chamber”), as illustrated by FIG. 2B. The metastable reduction chamber may, for instance be quite similar or identical to a collision cell. It may be beneficial to position the metastable reduction chamber as close as possible to the ionization volume or the detector surface. In other embodiments in which a collision cell is incorporated to cause collisions to generate fragment analytes, a gas mixture comprising the metastable reducing gas in combination with the collision gas can be created outside of the mass spectrometer and introduced into the collision cell as a mixed gas as illustrated in FIG. 2A.

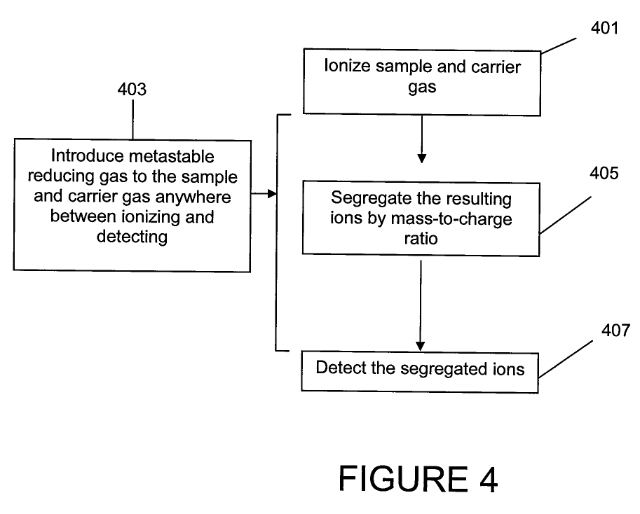

FIG. 4 is a flow diagram illustrating a basic process of mass spectrometry in accordance with the principles of the present invention. In block 401, a sample carried in a carrier gas is ionized, such as in an ionization volume as illustrated in the FIGS. 1 and 2. In block 403, the metastable reducing gas is introduced to the sample and carrier gas to cause collisions between the molecules of the metastable reducing gas and any metastables of the carrier gas contained in the carrier gas and sample gas. As previously noted, the collision process may occur anywhere in the process after the ionization of the sample and before the detection of the ions. Next, in block 405, the ions are segregated by their mass-to-charge ratios using any suitable technique and/or mass analyzer apparatus. Finally, in block 407, the segregated ions are detected so that they can be measured qualitatively and/or quantitatively to determine the constituents of the sample gas and/or the concentrations of those constituents.

### EXEMPLARY EMBODIMENTS OF THE INVENTION

Embodiments of the present invention include, without being limited to, the following:

1. A method of performing, in a mass spectrometer, mass spectrometry on a sample that may contain analytes, comprising:

ionizing the sample to create ions of analytes in the sample;

segregating the resulting ions by mass-to-charge ratio;

detecting the segregated ions with a detector; and

introducing a metastable reducing gas into the mass spectrometer after ionizing and before detecting.

2. The method of embodiment 1 wherein the sample is accompanied by a carrier gas and wherein the metastable reducing gas is of a species having an excited energy state similar to the energy state of metastables of the carrier gas.
3. The method of embodiment 2 wherein the metastable reducing gas and the carrier gas are of the same species.
4. The method of embodiment 3 wherein the carrier gas and the metastable reducing gas are both helium.
5. The method of any one of embodiments 1-4 wherein the introducing occurs after the segregating.
6. The method of any one of embodiments 1-4 wherein the ions are passed through a chamber between the ionizing and the detecting, wherein the chamber contains the metastable reducing gas.
7. The method of embodiment 6, wherein the chamber is a collision cell, and the method further comprises segregating the ions by mass-to-charge ratio a second time between the collision cell and the detecting.
8. The method of any one of embodiments 1-6 further comprising:

passing the ions through a collision cell between the segregating and the detecting; and

segregating the ions by mass-to-charge ratio a second time between the collision cell and the detecting;

wherein the introducing occurs between the second segregating and the detecting.

9. A mass spectrometer comprising:

a flow path for a sample, the flow path including:
a receiving input for receiving a sample;
an ion source including an ionization volume in which ions are created from analytes present in the sample;
a mass analyzer receiving the ions and segregating ions as a function of the mass-to-charge ratio of the ions; and
a detector having a detector surface for detecting ions segregated by the mass analyzer; and

a mixing chamber having a first input port for introducing a first gas into the mixing chamber, a second input port for introducing a second gas into the mixing chamber, and an output port disposed between the ionization volume and the detector surface through which a mixture of the first gas and the second gas is introduced into the flow path for the sample.

10. The mass spectrometer of embodiment 9, further comprising:

a collision cell between the mass analyzer and the detector; and

wherein the output port is disposed to introduce the mixture into the collision cell.

11. A mass spectrometer comprising:

an input port for receiving a sample;

an ion source including an ionization volume in which ions are created from analytes present in the sample;

a mass analyzer receiving the ions and segregating ions as a function of the mass-to-charge ratio of the ions;

a detector having a detector surface for detecting ions segregated by the mass analyzer;

a first port disposed between the ionization volume and the detector surface through which a metastable reducing gas may be introduced into the mass spectrometer; and

a second port disposed between the ionization volume and the detector surface through which a collision gas may be introduced into the mass spectrometer for fragmenting the ions of the sample.

12. The mass spectrometer of embodiment 11, further comprising:

a collision cell between the mass analyzer and the detector; and

wherein the first port and the second port are disposed to introduce the first gas and the second gas, respectively, into the collision cell.

13. The mass spectrometer of embodiment 11, further comprising:

a chamber between the ionization volume and the detector surface, and the first port is coupled with the chamber to introduce the metastable reducing gas to the chamber; and

a collision cell between the ionization volume and the detector surface, and the second port is coupled with the collision cell to introduce the collision gas to the collision cell.

14. A mass spectrometer comprising:

an input port for receiving a sample;

an ion source including an ionization volume in which ions are created from analytes present in the sample;

one and only one mass analyzer receiving the ions and segregating ions as a function of the mass-to-charge ratio of the ions, wherein the mass analyzer is not an ion trap;

a detector having a detector surface for detecting ions segregated by the mass analyzer; and

a port disposed between the ionization volume and the detector surface through which a metastable reducing gas may be introduced into the mass spectrometer.

15. The mass spectrometer of embodiment 14, wherein the port is between the mass analyzer and the detector surface.
16. The mass spectrometer of embodiment 14, further comprising:

a chamber between the ionization volume and the detector surface, and the port supplies the metastable reducing gas to the chamber.

17. The mass spectrometer of any one of embodiments 14-16, further comprising:
a gas chromatograph or liquid chromatograph having an output to provide the sample to the input.
   18. The mass spectrometer of embodiment 14, wherein the mass analyzer is a quadruple mass analyzer.
   19. The mass spectrometer of any one of embodiments 9-13, comprising a quadruple mass analyzer.
   20. A mass spectrometer comprising:

a receiving input for receiving a sample;

an ion source including an ionization volume in which ions are created from analytes present in the sample;

a mass analyzer receiving the ions and segregating ions as a function of the mass-to-charge ratio of the ions;

a detector having a detector surface for detecting ions segregated by the mass analyzer; and

a volume located between the ionization volume and the detector surface containing a metastable reducing gas, the metastable reducing gas being a species selected such that collisions between molecules of the metastable reducing gas and metastables accompanying the sample cause the metastables to return to a stable energy state.

21. The mass spectrometer of embodiment 20 wherein the sample is accompanied by a carrier gas and wherein the metastable reducing gas is of a species having an excited energy state similar to the energy state of metastables of the carrier gas.
22. The mass spectrometer of embodiment 21 wherein the carrier gas and the metastable reducing gas are the same species.
23. The mass spectrometer of any one of embodiments 20-22 further comprising:

a gas chromatograph having an output to provide the sample to the receiving input.

24. The mass spectrometer of any one of embodiments 20-23 wherein the volume is between the mass analyzer and the detector surface.
25. The mass spectrometer of any one of embodiments 20-24 further comprising:

a collision cell between the mass analyzer and the detector.

26. The mass spectrometer of embodiment 25, wherein the volume is in the collision cell.
27. A method for reducing noise in mass spectrometry performed with a mass spectrometer, comprising:

ionizing a sample to create ions of analytes in the sample;

analyzing the resulting ions by mass-to-charge ratio;

detecting the segregated ions with a detector; and

introducing a metastable reducing gas into the mass spectrometer after the ionizing and before the detecting.

28. The method of embodiment 27 wherein the sample is accompanied by a carrier gas and wherein the metastable reducing gas is of a species having an excited energy state similar to the energy state of metastables of the carrier gas.
29. The method of embodiment 28 wherein the metastable reducing gas and the carrier gas are of the same species.
30. The method of embodiment 29 wherein the carrier gas and the metastable reducing gas are both helium.
31. The method of any one of embodiments 27-30 wherein the introducing occurs after the segregating.
32. The method of any one of embodiments 27-30 wherein the ions are passed through a chamber between the ionizing and the detecting, wherein the chamber contains the metastable reducing gas.
33. The method of embodiment 32, wherein the chamber is a collision cell, and the method further comprises segregating the ions by mass-to-charge ratio a second time between the collision cell and the detecting.
34. The method of any one of embodiments 27-32 further comprising:

passing the ions through a collision cell between the segregating and the detecting; and

segregating the ions by mass-to-charge ratio a second time between the collision cell and the detecting;

wherein the introducing occurs between the second segregating and the detecting.

While the invention has been described above in connection with a series of exemplary embodiments in the form of gas phase mass spectrometers, it should be understood that the innovative concepts introduced herein can be applied to reduce noise in a mass spectrometer in connection with any sample that is accompanied by another species of gas or fluid that could generate noise, regardless of whether the species is part of the sample itself, part of a transport mechanism for the sample, or otherwise.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A method of performing, in a mass spectrometer, mass spectrometry on a sample that may contain analytes, comprising:
ionizing the sample to create ions of analytes in the sample;
segregating the resulting ions by mass-to-charge ratio;
detecting the segregated ions with a detector; and
introducing a metastable reducing gas into the mass spectrometer after ionizing and before detecting.

2. The method of claim 1 wherein the sample is accompanied by a carrier gas and wherein the metastable reducing gas is of a species having an excited energy state similar to the energy state of metastables of the carrier gas.

3. The method of claim 2 wherein the metastable reducing gas and the carrier gas are of the same species.

4. The method of claim 3 wherein the carrier gas and the metastable reducing gas are both helium.

5. The method of claim 1 wherein the introducing occurs after the segregating.

6. The method of claim 1 wherein the ions are passed through a chamber between the ionizing and the detecting, wherein the chamber contains the metastable reducing gas.

7. The method of claim 6, wherein the chamber is a collision cell, and the method further comprises segregating the ions by mass-to-charge ratio a second time between the collision cell and the detecting.

8. The method of claim 1 further comprising:
passing the ions through a collision cell between the segregating and the detecting; and
segregating the ions by mass-to-charge ratio a second time between the collision cell and the detecting;
wherein the introducing occurs between the second segregating and the detecting.

9. A mass spectrometer comprising:
a flow path for a sample, the flow path including:
a receiving input for receiving a sample;
an ion source including an ionization volume in which ions are created from analytes present in the sample;
a mass analyzer receiving the ions and segregating ions as a function of the mass-to-charge ratio of the ions; and
a detector having a detector surface for detecting ions segregated by the mass analyzer; and
a mixing chamber having a first input port for introducing a first gas into the mixing chamber, a second input port for introducing a second gas into the mixing chamber, and an output port disposed between the ionization volume and the detector surface through which a mixture of the first gas and the second gas is introduced into the flow path for the sample.

10. The mass spectrometer of claim 9, further comprising:
a collision cell between the mass analyzer and the detector; and
wherein the output port is disposed to introduce the mixture into the collision cell.

11. A mass spectrometer comprising:
an input port for receiving a sample;
an ion source including an ionization volume in which ions are created from analytes present in the sample;
a mass analyzer receiving the ions and segregating ions as a function of the mass-to-charge ratio of the ions;
a detector having a detector surface for detecting ions segregated by the mass analyzer;
a first port disposed between the ionization volume and the detector surface through which a metastable reducing gas may be introduced into the mass spectrometer; and
a second port disposed between the ionization volume and the detector surface through which a collision gas may be introduced into the mass spectrometer for fragmenting the ions of the sample.

12. The mass spectrometer of claim 11, further comprising:
a collision cell between the mass analyzer and the detector; and
wherein the first port and the second port are disposed to introduce the first gas and the second gas, respectively, into the collision cell.

13. The mass spectrometer of claim 11, further comprising:
a chamber between the ionization volume and the detector surface, and the first port is coupled with the chamber to introduce the metastable reducing gas to the chamber; and
a collision cell between the ionization volume and the detector surface, and the second port is coupled with the collision cell to introduce the collision gas to the collision cell.

14. A mass spectrometer comprising:
an input port for receiving a sample;
an ion source including an ionization volume in which ions are created from analytes present in the sample;
one and only one mass analyzer receiving the ions and segregating ions as a function of the mass-to-charge ratio of the ions, wherein the mass analyzer is not an ion trap;
a detector having a detector surface for detecting ions segregated by the mass analyzer; and
a port disposed between the ionization volume and the detector surface through which a metastable reducing gas may be introduced into the mass spectrometer.

15. The mass spectrometer of claim 14, wherein the port is between the mass analyzer and the detector surface.

16. The mass spectrometer of claim 14, further comprising:
a chamber between the ionization volume and the detector surface, and the port supplies the metastable reducing gas to the chamber.

17. The mass spectrometer of claim 14, further comprising:
a gas chromatograph having an output to provide the sample to the input.

18. The mass spectrometer of claim 14, wherein the mass analyzer is a quadruple mass analyzer.
